(19) United States
(12) Patent Application Publication
(10) Pub. No.: US 2008/0270168 A1
(43) Pub. Date: Oct. 30, 2008

(54) SYSTEM AND METHODS FOR SPONSORED BIOMEDICAL PRESENTATIONS

(76) Inventor: Stephen W. Trzeciak, Moorestown, NJ (US)

Correspondence Address: WOODCOCK WASHBURN LLP, CIRA CENTRE, 12TH FLOOR, 2929 ARCH STREET, PHILADELPHIA, PA, 19104-2891, US

(21) Appl. No.: 12/108,091

(22) Filed: Apr. 23, 2008

Related U.S. Application Data
(60) Provisional application No. 60/913,599, filed on Apr. 24, 2007.

(51) Int. Cl. G06Q 99/00

(52) U.S. Cl. 705/1

(57) ABSTRACT

The disclosed methods and systems may broker blind exchanges between and/or among the parties in the process of creating sponsored biomedical education programs, such as commercial interest sponsors, presenters, hosts, and/or facilitators. Blinding may introduce a separation between a source of funding and a biomedical presentation being funded, effectively eliminating real and/or apparent financial conflicts of interest. In a blinding transaction, first data describing an aspect of a biomedical presentation may be received. The biomedical presentation may be associated with a presenter. Second data indicative of an intent of a sponsoring entity to sponsor delivery of the biomedical presentation may be received. The first data may be associated with the identity of the sponsor. An indication to deliver the biomedical presentation may be generated. The indication preferably does not disclose the identity of the sponsoring entity to the presenter.

### CROSS REFERENCE TO RELATED APPLICATIONS

This application claims benefit of U.S. Provisional Application No. 60/913,599, filed Apr. 24, 2007 which is incorporated herein, in its entirety.

### TECHNICAL FIELD

The technical field of the disclosure relates generally to sponsored scientific communications. More specifically, the disclosure relates to systems and methods for reducing conflicts of interest, bias, and/or the appearance thereof in sponsored biomedical presentations.

### BACKGROUND

Financial conflicts of interest in sponsored biomedical presentations are a threat to public health. Biomedical presentations, such as Continuing Medical Education (CME) programs, educate healthcare practitioners in advances in health science, improving clinical practice and directly affecting patients' lives. Continuing Medical education is vital to healthcare effectiveness, but preparing, authoring, and delivering biomedical presentations is expensive. In the United States, the biomedical industry (e.g., pharmaceutical and medical device companies) funds the majority of educational presentations. Financial relationships, such as honoraria, consulting fees, etc., between these commercial sponsors and the educational presenters create skepticism of the presenter's independence and doubt regarding the validity of the research, findings, guidelines, and/or advice contained in the presentation itself. These financial conflicts of interest have blurred the line between science and solicitation. However, a majority of advances in medicine and biotechnology have come from the biomedical industry, so it is important for the public health that these and other medical advances are effectively and independently communicated to healthcare practitioners.

Industry-sponsored presentations (e.g. lectures, articles, etc.) that are focused on new advances in the biomedical sciences have historically been tainted by financial conflicts of interest. When the presenters are also researchers, these financial conflicts of interest can also taint the presenter's original research. In fact, in some particularly well-publicized cases, the identification of undisclosed financial relationships (i.e. honoraria, speaking fees, consulting fees, etc.) between presenters and industry has called the validity of the presenters' research findings into question. The depth and scope of this problem has been chronicled in both scientific journals and the lay press. As a result, biomedical research, especially clinical research, is now viewed with a degree of skepticism in both the public eye and the scientific community at large.

These same financial conflicts of interest also typically plague the publication of “clinical practice guidelines” in journals. Even though the vast majority of clinical investigators and biomedical opinion leaders participating in these sponsored forums are honorable individuals of high ethical integrity, their financial conflicts of interest with industry (e.g. past and ongoing honoraria payments for biomedical presentations) may result in biased recommendations to the medical community at large.

Moreover, it is well known that the vast majority of advances or “breakthroughs” in medicine and biotechnology that can lead to healthcare improvement are the products of industry discoveries. In fact, without the work of industry, many of the important advances that we currently take for granted in healthcare would never have been realized. As industry has driven much of the progress in biomedical research, industry also has a vested interest in having these advances effectively communicated to healthcare practitioners. As a result, industry not only drives the research but also is a potent stimulus for advancing biomedical education worldwide.

Historically, the problem of financial conflicts of interest in biomedical communication has been addressed using a “full disclosure” model. Most of the efforts aimed at mitigating financial conflicts of interest in medicine and biotechnology have focused on how best to accomplish full disclosure. Presenters in CME programs are expected to disclose all financial conflicts of interest to the audience before giving a CME presentation. In addition, many journal editors require detailed disclosures (e.g. in some cases even requiring itemized disclosures with dollar amounts) from authors submitting manuscripts for peer review, regardless of whether or not the financial relationship actually represents a conflict with the content of the paper.

Unfortunately, the full disclosure model has largely been a failure. Disclosure is simply not enough to eliminate bias and/or the appearance of bias. Even if full disclosure is successfully achieved, bias on the part of presenters and/or authors may always be suspected and can be impossible to detect. It is difficult or impossible to know whether or not any bias, either consciously or subconsciously, has crept into authors' statements.

Moreover, financial disclosures can actually undermine public confidence in a presenter's message and can introduce skepticism. Financial disclosures force audiences to assess motives and wonder if the presenter is incapable of producing unbiased information. This can jeopardize trust in the presenter.

Furthermore, in order to avoid financial disclosures and the accompanying skepticism, many of our most prominent biomedical scientists have likely been deterred from accepting invitations to any type of sponsored educational program. Renowned biomedical thought leaders (especially those who intend to publish in peer-reviewed journals) can no longer participate in sponsored educational programs without considering the risk of damaging their reputations. These thought leaders with the greatest insight into the science are being widely replaced in educational programs by less qualified local “experts” who are willing to have financial conflicts of interest. The absence of the true thought leaders from this educational process would mean that the leading experts in the field would not be heard and would not be the ones educating our healthcare practitioners. The quality of CME programs would suffer as a result.

In addition, commercial CME providers, CME companies, medical education companies (MECs), or other third party facilitators using funding from commercial interest sponsors now serve as brokers and coordinators for a high percentage of the sponsored biomedical communications in the United States. In discussing these arrangements, a well known book on the topic of financial conflicts of interest in biomedical communication, “On the take: How medicine's complicity with big business can endanger your health” by Jerome P. Kassirer M. D., former Editor-in-Chief of New England Journal of Medicine, states that the sponsor is always known by the presenters/authors:
A biomedical communicator is “always going to know which company sponsored the programs and could potentially be influenced by the arrangement” (p. 203).

Restricting or excluding industry funding from the process is unlikely to be an effective strategy for reforming biomedical education. The frequency and quality of these educational programs would undoubtedly suffer as a result. There are expenses involved in bringing presenters to a forum. These expenses typically include payment of an honorarium for the presenters' time in preparing and/or delivering the presentation. If program faculty were not compensated for their time investment in these programs, it is likely that their ability to participate would be significantly curtailed and that the quality of CME programs would suffer.

Effective CME is necessary in order to (1) keep practitioners up to date on the newest advances in medicine and biotechnology, and (2) advance the overall educational mission in the biomedical sciences. The most effective means of educating healthcare professionals is a model in which healthcare practitioners have access to presentations from the most renowned thought leaders in a forum of unbiased scientific exchange. Financial conflicts of interest between presenters and industry create bias and/or the appearance of bias, weakening the educational value of CME programs. Accordingly, effective medical education that enables sponsored biomedical presentations to be prepared, authored, and delivered free from financial conflicts of interest is vital to the public health.

### SUMMARY

The disclosed methods and systems blind sponsorship of biomedical presentations. These methods and systems may eliminate or at least reduce financial conflicts of interest in biomedical presentations (such as Continuing Medical Education programs) and/or broker blind exchanges between and/or among the parties in the process of coordinating biomedical presentations, such as commercial interest sponsors, presenters, hosts, and third party facilitators. A separation may be introduced between a source of funding and the biomedical presentation being funded, effectively eliminating real and/or apparent financial conflicts of interest.

In certain blinding transactions, first data describing an aspect of a biomedical presentation may be received. The biomedical presentation may be associated with a presenter. The first data may include a topic/outline of the biomedical presentation. The first data may be included in a portfolio of biomedical presentations available to be delivered by the presenter. For example, the first data may be available at a website for a potential sponsor to view. The first data may also be generated by a sponsor or third party facilitator and offered to a presenter with an invitation to present.

Blinding transactions may also include receiving second data indicative of an intent that the biomedical presentation be delivered. For example, the second data may be indicative of an intent of an entity to sponsor delivery of the biomedical presentation. For example, the second data may be indicative of an intent to provide consideration (i.e. honorarium) to the presenter for the preparation and/or delivery of the biomedical presentation. The sponsoring entity may search, view, and select available content for a presentation including presenter and topic/outline. The second data may include a selection of one or more of the presentations for delivery. For example, the second data may include a list of presentations that are acceptable to the sponsoring entity for funding, and one or more presentations may be selected on the sponsoring entity's behalf for funding. The second data may also be generated in response to an invitation to sponsor a specific presentation with predetermined content including presenter and/or topic/outline.

In certain embodiments, the first data may be associated with the identity of the sponsoring entity. The association may be a logical database linkage associating the delivery of the presentation with the sponsoring entity.

An indication to deliver the biomedical presentation may be generated. The indication may be sent to the presenter. The indication preferably does not disclose the identity of the sponsoring entity to the presenter. Thus, the presenter may present the biomedical presentation having been funded by the sponsoring entity without learning the identity of the sponsor. The financial transaction between the sponsor and the presenter may be coordinated through an interface without the presenter learning the identity of the sponsor and without the sponsor learning the identity of the presenter. Attendees of the presentation may receive electronic invitations to the presentation, and the electronic invitations may indicate the terms of the blinding.

The presenter delivers the presentation in accordance with the generated indication without knowing the identity of the sponsor. The biomedical presentation can be delivered free of any financial conflicts of interest and free of any appearance of bias because the presenter is not aware of the sponsor's identity. Following the delivery of the presentation, the identities of the sponsor may be disclosed.

Information indicating whether the presenter knew the identity of the sponsoring entity before delivering (or generating) the biomedical presentation may be collected. A compliance metric, based on the collected information, may be generated. The compliance metric may be used to determine blinding effectiveness and to identify sponsors and/or presenters that are not being effectively blinded. A corrective action may be taken based on the compliance metric. The compliance metric may be used by the sponsor in regulatory affairs in order to demonstrate that the sponsor's sponsored programs are effectively blinded.

### BRIEF DESCRIPTION OF THE DRAWINGS

FIG. 1 is a block diagram illustrating a prior art scenario for sponsored biomedical presentations.

FIG. 2 is a block diagram depicting an exemplary system for facilitating sponsored biomedical presentations.

FIG. 3 is a flow chart depicting an exemplary process for facilitating sponsored biomedical presentations.

FIG. 4 depicts an exemplary system for facilitating sponsored biomedical presentations.

FIGS. 5A-D depict exemplary user interfaces for facilitating sponsored biomedical presentations, including a sponsor interface, a presenter interface, a host interface, and an administrative interface, respectively.

### DETAILED DESCRIPTION

It will be understood that the term “may,” as used herein to refer to embodiments of the disclosed inventions and/or features thereof, is intended to identify subject matter that is optional (and, perhaps, even preferred) but not necessarily required. Thus, a statement that “data may be received” in connection with a disclosed method is intended to indicate the possibility, but not the requirement, that the method include the step of receiving data.

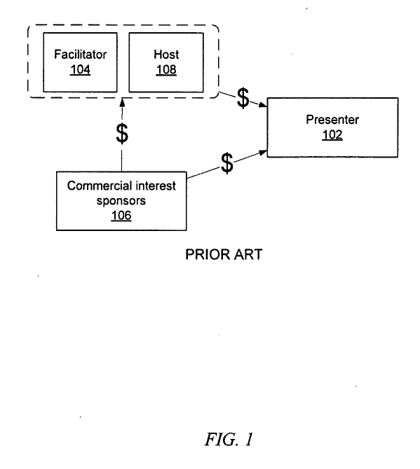

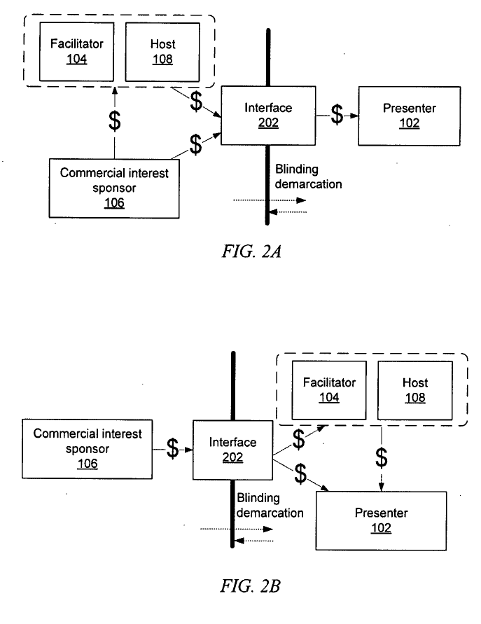

As shown in FIGS. 1-2B, the parties involved in the sponsorship, preparation, creation, facilitation, coordination, delivery, etc. of biomedical presentations may include presenters 102, facilitators 104, commercial interest sponsors 106, hosts 108 and the like (defined below). Biomedical presentations may include any medium such as live presentations, oral communications, written publications, video displays, media programs, computer-aided communications, webcasts, video or slide or other media presentations for download from the internet, audio programs for download (i.e. “podcasts”), and the like. Biomedical presentations may relate to healthcare goods and/or services consumed by, and/or used on patients. Preferably, the biomedical presentation is prepared, authored and/or delivered by presenters who are biomedical thought leaders that are engaged in creating new biomedical content, are distinguished academicians and/or are otherwise regarded by their peers as opinion or thought leaders in their field.

Biomedical presentations may be presented in oral form (e.g., talks using audiovisual aides like PowerPoint slides or videos) and/or written form. Biomedical presentations may include lectures and/or scientific communications presented in oral form, including invited lectures, speaking engagements, roundtable talks, etc. Biomedical presentations may include “grand rounds,” CME programs, panel discussions, or roundtable discussions. Biomedical presentations may be presented in-person or remotely, by webcast, podcast, real-time feed, video-on-demand, etc. Biomedical presentations may include education media programs such as web-based programs, video programs, or audio programs. Biomedical presentations may include print publications and/or commissioned authorship of written works including electronic publications and print publications.

One or more attendees may receive and/or consume the content of the biomedical presentation. The attendee may be present at an assembled audience at a live presentation. The attendee may include an individual listening to the presentation via webcast, audio podcast, etc. The attendee may include an individual viewing a webcast, video podcast, video broadcast, etc. The attendee may include an individual reading a publication. The attendee may include physicians, healthcare administrators, non-clinician scientists, nurses, therapists, technicians, any allied health professional, or the like.

Presenters 102 may include individuals and/or entities that create and/or deliver biomedical presentations. Presenters 102 may deliver biomedical presentations in written form (e.g., printed and electronic writing), oral form (e.g., lecture), audio/visual form (e.g., slide presentation, video program, webcast, podcast, downloaded media, etc.), and the like. The presenter 102 may engage in research and/or may develop educational materials. The presenter 102 may be a thought leader and/or expert in a specified field. Preferably, the biomedical presenter 102 is a medical doctor.

Facilitators 104 may provide coordination efforts for a sponsored biomedical presentation that may relate to meeting space, scheduling, promotional materials, review and selection of presenter(s), payment of honoraria on behalf of sponsors, and any other logistical considerations related to the production of a sponsored biomedical presentation. Facilitators 104 may include CME companies, commercial CME providers, or “medical education companies (MEC)”. Facilitators 104 may include third parties through which commercial interest entities channel funding in the sponsorship of biomedical presentations. The third party facilitator 104 may sponsor a biomedical presentation with funding that originated from a commercial interest sponsor 106.

Hosts 108 may provide a venue, environment, or context in which the biomedical presentation is delivered. Hosts 108 may also provide an endorsement under which the presentation is delivered, or a commission under which the presentation is delivered. Hosts 108 may be a hospital, medical center, clinic, academic institution, and the like. Biomedical presentations may also be held at scientific meetings (or in off-site forums at or near the time of scientific meetings) and may include meetings of medical professional societies and may include scientific sessions as part of the official scientific program, satellite symposia, or mini-symposia. Live presentations may take place at a variety of locations, such as hospitals, medical centers, clinics or their facilities, or they may be held in restaurants, hotels, or any other private property non-medical venues, and may include dinner programs, lunch programs, or breakfast (or “daybreak”) programs. A facilitator 104 may also serve as a host 108 of a sponsored biomedical presentation. A facilitator 104 and/or a host 108 may host an on-line or downloadable biomedical presentation on a computer server.

A commercial interest sponsor 106 may include individuals and/or entities that produce health care goods and/or services consumed by, and/or used on patients or in the care of patients and the individuals, companies, trade associations and/or other groups acting on their behalf. For example, commercial interest sponsors 106 may include, for example, pharmaceutical, medical device, biotechnology, biologics, or bioinformatics companies (collective referred to as “industry” in medicine) and their representatives or agents acting on their behalf. Sponsors 106 may provide funding, directly and indirectly, to support biomedical presentations, including educational programs and invited lectures and other speaking engagements. Typically this sponsorship includes providing consideration (i.e. an honorarium) to the presenter 102.

FIG. 1 is a block diagram illustrating a prior art scenario for sponsored biomedical presentations. It is well known that commercial interest sponsors 106 fund biomedical presentations directly and/or indirectly. The funding is not blinded. The parties are aware of the other parties in the transaction (i.e., the presenter knows the identity of the commercial interest sponsor from which the funding is supplied).

The biomedical presenter 102 may be paid directly by a commercial interest sponsor 106. For example, the funding may be part of a promotional program. The sponsor 106 may directly fund presenters 102 to present on a certain topic or in a certain field. Sometimes, the presenter 102 may establish an entity that receives the consideration.

The biomedical presenter 102 may be paid indirectly by a commercial interest sponsor 106 via a third party, either a facilitator 104 and/or a host 108. Sponsors 106 may provide funding indirectly to biomedical presenters 102 through a third party facilitator 104 (e.g. CME companies, commercial CME providers, medical education companies, medical communication companies (MECs), third party brokers, and the like) that produce or coordinate conferences and programs, such as educational programs. Sponsors 106 may fund biomedical presenters 102 through third party facilitators 104 that do not have any legitimate grounding in a medical professional society or other scientific group. The commercial interest sponsor 106 may provide unrestricted educational grants, cash, or in kind support to the facilitator 104 to sponsor a program, and then the facilitator 104 selects the biomedical presenter 102 and passes the money on to the presenter 102. The facilitator 104 may effectively secure the biomedical presenter on behalf of the commercial interest sponsor 106. Not surprisingly, the funded biomedical presenters 102 tend to speak favorably about the products of the sponsoring commercial interests.

Sponsors 106 may provide funding indirectly to biomedical presenters 102 through a host 108. For example, commercial interest sponsors 106 may provide unrestricted educational grants to a host 108 (e.g. hospital, medical center, or academic institution) to sponsor a program. The host may pass the money on to the presenter 102. Scientific meetings (e.g. specifically those that include industry-supported symposia as part of the scientific program), professional society commissioned projects (e.g. for the creation of “clinical practice guidelines” or review article projects that are supported with industry funding), independent educational projects, clinical guidelines writing projects, and hospital or medical center-based CME offices also receive funding from commercial interest sponsors 106 that could be passed on to presenters 102 in exchange for scientific communication.

Various codes of ethics related to interactions between commercial interests and healthcare practitioners recognize that the biomedical presenter must disclose the identity of commercial interests that support them with funding or in-kind support in the sponsored presentation. (e.g., Accreditation Council for Continuing Medical Education “ACCME” Standards for Commercial Support: Standards to Ensure the Independence of CME Activities; Advanced Medical Technology Association “AdvaMed” Code of Ethics on Interactions with Healthcare Professionals; and Pharmaceutical Research and Manufacturers of America “PhRMA” Code on Interactions with Healthcare Professionals). The ACCME is the official accrediting body for Continuing Medical Education programs. AdvaMed is the world's largest trade association for innovators and manufacturers of medical devices, diagnostic products and medical information systems. PhRMA is a trade group representing the pharmaceutical research and biotechnology companies in the United States. Neither the codes of ethics from these organizations nor the aforementioned book by Kassirer mention securing sponsorship without identifying the sponsor or otherwise blinding the presenters 102 to the commercial interest sponsors 106.

FIGS. 2A and 2B are block diagrams depicting an exemplary system for facilitating sponsored biomedical presentations. This non-limiting example illustrates a blinding demarcation between a commercial interest sponsor 106 of funding and a presenter 102 (i.e., the presenter 102 is blinded from knowing the identity of the commercial interest sponsor 106). The blinding may reduce financial conflicts of interest, bias, and the appearance of bias in sponsored biomedical presentations. Preferably, the blinding demarcation may be a “one-way” blinding mechanism. For example, the presenter 102 may be blinded from the identity of the sponsoring commercial interest 106, but the identity of the presenter 102 may be known to the sponsoring commercial internet 106.

As illustrated in FIG. 2A, the presenter 102 may be blinded from knowing the identity of the commercial interest sponsor 106 and/or the third party facilitator 104. As illustrated in FIG. 2B, the presenter 102 and/or the third party facilitator 104 and/or the host 108 may be blinded from knowing the identity of the commercial interest sponsor 106.

Blinding may be achieved by the introduction of an interface 202 into the interaction among the parties. The interface 202 may be an agent acting on behalf of the biomedical presenter 102 to ensure that the biomedical presenter 102 remains blinded to the identity of the commercial interest sponsor 106. The interface 202 may be an agent acting on behalf of the commercial interest sponsor 106 to ensure that the biomedical presenter 102 remains blinded to the identity of the commercial interest sponsor 106. The interface 202 may be an agent acting on behalf of the facilitator 104 to ensure that the biomedical presenter remains blinded to the identity of the commercial interest sponsor 106. The interface 202 may be an independent party, entity, and/or individual.

The interface 202 may be disposed between the commercial interest sponsor 106 and the presenter 102. The interface 202 may send and/or receive data related to a biomedical presentation. The interface 202 may coordinate a match between sponsor 106 and presenter 102 without revealing the identity of the sponsor 106 to the presenter 102.

In an embodiment, the interface 202 may associate sponsors 106 and presenters 102 by allowing sponsors 106 to browse or shop for presentations based on general content and outlines and/or based on the identity of the presenter 102. For example, the interface 202 may receive data associated with the biomedical presentation from the presenter 102, such as a title, outline and/or abstract. The interface 202 may enable a sponsor 106 (or agent acting on their behalf or with their funding, such as a facilitator 104 or host 108) to browse, search, select, and or decide on a presentation to sponsor, without revealing the identity of the sponsor 106 to the presenter 102. For example, the interface 202, responsive to a query, may send the outline and/or abstract as part of a list to the sponsor 106 (or agent acting on their behalf or with their funding, such as a facilitator 104 or host 108). The interface 202 may receive data from the sponsor 106 (or agent acting on their behalf or with their funding, such as a facilitator 104 or host 108) indicating intent to fund a specified presentation. The interface 202 may associate the sponsor 106 with the specified presentation and may generate an indication that to the presenter 102 that the presentation has been funded. The indication from the interface 202 preferably does not disclose the identity of the sponsor 106 to the presenter 102. For example, the indication may be an electronic message and/or invitation to the presenter 102 to present the biomedical presentation that does not reveal the identity of the sponsor 106.

In one embodiment, the interface 202 may associate facilitators 104 and/or hosts 108 and presenters 102, and then solicit interaction from the sponsors 106. The interface 202 may allow facilitators 104 and/or hosts 108 to select presentations based on their needs. Once the presentation has been selected, the interface 202 may send a request to applicable sponsors 106, soliciting them to fund the specific delivery of the presentation. The sponsors may respond with an assent to funding the specific presentation.

Interface 202 may also generate agreements related to the sponsorship and delivery of the presentation that require the agreeing party not to reveal the identity of the sponsor 106 to one or more of the other parties and/or to report to the interface 202 if the agreeing party receives knowledge that the presenter 102 gained knowledge of the sponsor 106. The interface 202 may generate “click-through” digital contracts and/or agreements via a website interface. The contracts and/or agreements may, in real-time, be generated specific to the parties and the circumstances of a specific biomedical presentation.

To illustrate, the sponsor 106 may assent to a general agreement associated with use of the interface 202. Then, once the sponsor 106 agrees to sponsor a specific presentation, another, more specific, agreement for said specific presentation may be generated for the sponsor 106, in which the sponsor 106 agrees not to disclose the identity of the sponsor 106 to the presenter 102. For example, the presenter 102 may assent to a general agreement associated with use of the interface 202. The general agreement may be generated for the presenter 102 when the presenter 102 uploads or otherwise transmits data associated with a biomedical presentation. Later, when the interface 202 generates an indication that the presenter 102 is to deliver the biomedical presentation, the interface 202 may generate a specific agreement for the presenter 102 associated with the delivery of a specific sponsored presentation. The agreement may require the presenter 102 to avoid learning the identity of the sponsor 106. The agreement may require the presenter 102 to report if he or she gains any knowledge of the identity of the sponsor 106. All of these agreements preferably would be contracts, including for example digital contracts.

The interface 202 may enable an exchange of consideration associated with the presentation. For example, the interface 202 may receive consideration associated with a presentation from the commercial interest sponsor 106 and/or the third party facilitator 104 acting on behalf of the commercial interest sponsor 106 and/or a host 108. The interface 202 may distribute the consideration to the presenter 102 without communicating to the presenter 102 the identity of the commercial interest sponsor 106.

The interface 202 may enable various exchanges of information and/or consideration associated with the parties. In one embodiment, the interface 202 receives information describing one or more aspects of a biomedical presentation, receives consideration associated with the delivery of the biomedical presentation (directly or indirectly) from an sponsor 106 that has an identity, and distributes (or agrees to distribute) consideration to the presenter 102 who agrees to present the biomedical presentation. In another embodiment, the interface 202 receives information describing one or more aspects of a biomedical presentation, receives consideration associated with presentation of the biomedical presentation (directly or indirectly) from a sponsor 106 that has an identity, and distributes (or agrees to distribute) consideration to the presenter 102 who has delivered the biomedical presentation.

The interface 202 may receive data describing one or more aspects of a biomedical presentation. The interface 202 may receive consideration associated with the delivery of the biomedical presentation from a commercial interest sponsor 106 that has an identity. The interface 202 may distribute (or agree to distribute) at least a portion of the consideration to the presenter 102 who has agreed to deliver but has not yet delivered the biomedical presentation without communicating to the presenter 102 the identity of the sponsoring entity 106. The consideration received by the interface 202 may be provided directly by the commercial interest sponsor 106 or indirectly through a third party facilitator 104 (such as a CME company, or medical education company) or a host 108 (such as a hospital, medical center, academic institution, or scientific meeting). The consideration may be distributed before or after delivery of the biomedical presentation.

The interface 202 may receive consideration, such as an unrestricted educational grant, from a commercial interest sponsor 106 and then provide the consideration to a host 108 to sponsor a program and/or lecture. The commercial interest sponsor 106 may select the biomedical presentation and/or the venue where they would like to have the presentation delivered. The presentations may be shopped to hosts 108 on behalf of a commercial interest sponsor 106 without identifying the identity of the commercial interest sponsor 106 to the presenter 102 (and possibly the third party facilitator 104 and/or host 108) (as depicted in FIG. 2B).

The consideration exchanges may be in the form of an unrestricted grant, in-kind support, a liquid asset (e.g., cash), non-liquid asset, and the like. The consideration may be provided directly from the commercial interest sponsor 106. Alternatively, the consideration may be provided by a third party facilitator 104 and/or a host 108 that received the consideration from a commercial interest sponsor 106, for example, through an unrestricted educational grant or in-kind support, as depicted in FIG. 2A.

The commercial interest sponsor 106 may instruct the third party facilitator 104 to contact a presenter 102, via the interface 202, and to not inform the presenter 102 of the identity of the commercial interest sponsor 106. In one embodiment, a third party facilitator 104, such as a medical education company or commercial CME provider, does not disclose the identity of the sponsoring commercial interest 106 when it brokers an agreement for presenter's delivery of a sponsored biomedical presentation.

In one embodiment of the invention, an agent of a biomedical presenter 102 accepts a commercial interest sponsorship on behalf of the presenter 102, via the interface 202, and conceals the identity of the sponsoring commercial interest 106 from the presenter 102. Third party facilitators 104 or hosts 108 or other third parties using funding from commercial interests, may arrange biomedical presentations with presenters 102, via the interface 202, without identifying the sponsoring commercial interest 106. A presenter 102 may accept an invitation to prepare or present a biomedical presentation from an individual or entity that conceals the identity of the sponsoring commercial interest 106. Preferably, a presenter agrees to provide a biomedical presentation, sponsored with funding from a commercial interest sponsor 106, without knowing or learning the identity of the sponsoring commercial interest 106, and/or by agreeing to avoid learning and/or be blinded to the identity of the sponsoring commercial interest 106.

In another embodiment, the interface 202 acts on behalf of a non-U.S. presenter 102 by searching for or soliciting a commercial interest sponsor 106 with a place of business in the U.S., while failing, or refusing, to inform the presenter 102 of the identity of the sponsoring commercial interest 106, or while requiring the presenter 102 to agree to be blinded from the identity of the commercial interest sponsor 106, and/or otherwise taking actions to prevent the presenter 102 from learning the identity of the sponsoring commercial interest 106.

In other embodiments, the interface 202 may act on behalf of a commercial interest sponsor 106 and/or with funding from a commercial interest sponsor 106. The interface 202 may select a presenter 102 to deliver a biomedical presentation and, by rule and/or practice, prohibit, not permit, and/or protect the presenter 102 from learning the identity of a sponsoring commercial interest 106, or fail to, or refuse to, inform the presenter 102 of the identity of the sponsoring commercial interest 106.

The interface 202 may enable many different brokering scenarios among the parties. For example, a commercial interest sponsor 106 and/or facilitator 104 may want to create a sponsored educational program and has a host 108 but does not have a presenter 102 or specific topic/content. The commercial interest sponsor 106 and/or facilitator 104 may logon to the interface 202, view the presenters 102 available and the topics/content outlines, and select one or more outlines and/or presenters. In response, the interface 202 may send a blinded invitation to the presenter 102.

In another example, the sponsor 106 and/or facilitator 104 may not have a host already selected for the sponsored educational program. The interface 202 may send a blinded invitation to the presenter 102, as well as an invitation to a host 108 to host the program.

In another example, the commercial interest sponsor 106 and/or facilitator 104 may want to create a sponsored educational program with a specific topic/content, but does not have a presenter 102. The sponsor 106 and/or facilitator 104 may submit a topic (with or without a balanced outline of content). The interface 202 may send a blinded invitation to one or more presenters 102 to make a presentation that follows the topic submitted by the sponsor 106 or facilitator.

In another example, a host 108 and/or facilitator 104 may want to host a sponsored educational program but does not have a sponsor 106, presenter 102 or specific topic/content. The host 108 and/or facilitator 104 may logon to the interface 202, may view the presenters 102 available and the corresponding topics/content outlines. The host 108 and/or facilitator 104 may select a topic/content outline, and the interface 202 may send one or more blinded invitations to the presenter 102 and to one or more sponsors 106, inviting the sponsor to fund the program.

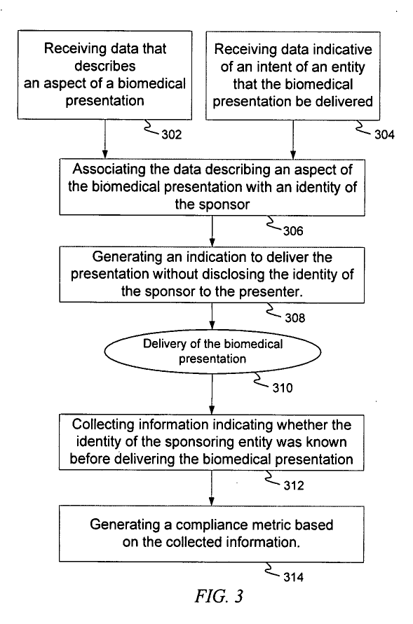

FIG. 3 is a flow chart depicting an exemplary process for facilitating sponsored scientific presentations. At 302, first data describing an aspect of a biomedical presentation may be received. The first data may be provided to an interface 202 from a presenter 102 who offers to deliver the biomedical presentation. The first data may be a copy of the biomedical presentation, an outline, an abstract, a slide deck, or the like. The first data may be part of a portfolio of presentations available from the presenter 102. The first data may indicate whether the biomedical presentation has been previously presented.

The first data may be associated with one or more substantive expectations. For example, the interface 202 may require that the biomedical presentation has balanced content. The receiving of the first data may be associated with receiving an agreement regarding one or more substantive aspects of the biomedical presentation. For example, the biomedical presentation preferably has greater than or equal to 30% of total content, time, and/or slide count focused on disease-state information (e.g., epidemiology and pathophysiology) and no more than 25% of total content, time, and/or slide count focused on any one specific proprietary drug or device.

At 304, second data indicative of an intent of the sponsoring entity 106 (or an agent acting on their behalf or with their funding, such as a facilitator 104 or host 108) to sponsor delivery of a biomedical presentation may be received. This intent may include intent to pay an honorarium to the presenter 102. The second data may be an indication of assent received via a website interface 202, for example. The second data may include an identity of the sponsoring entity 106.

In certain embodiments, the second data is received responsive to a query from the interface 202. The sponsor 106 (or agent acting on their behalf or with their funding, such as a facilitator 104 or host 108) may also search for biomedical presentations to sponsor. In response, the first data may be communicated to the sponsor 106 (or agent acting on their behalf or with their funding, such as a facilitator 104 or host 108). The first data may be transmitted among a portfolio of presentation outlines. The portfolio may enable the sponsor 106 (or agent acting on their behalf or with their funding, such as a facilitator 104 or host 108) to “shop” for one or more presentations of its choosing. The sponsor 106 (or agent acting on their behalf or with their funding, such as a facilitator 104 or host 108) may select an individual presentation for sponsorship. The sponsor 106 (or agent acting on their behalf or with their funding, such as a facilitator 104 or host 108) may select more than one presentation or presenter 102 and indicate that any of the selected would be acceptable to sponsor 106 (or agent acting on their behalf or with their funding, such as a facilitator 104 or host 108). In response, the interface 202 may select one presentation and presenter 102 from the list indicated as acceptable by the sponsor 106 (or agent acting on their behalf or with their funding, such as a facilitator 104 or host 108). In connection with the second data, the sponsor 106 (or agent acting on their behalf or with their funding, such as a facilitator 104 or host 108) may agree to certain terms, such as to not reveal the identity of the sponsor 106 to the presenter 102.

In certain embodiments, the sponsor 106 (or agent acting on their behalf or with their funding, such as a facilitator 104 or host 108) initiates the search for an acceptable presentation. For example, the sponsor 106 (or agent acting on their behalf or with their funding, such as a facilitator 104 or host 108) may search by name, subject, drug, device, condition, etc. for a presenter.

Alternatively, the second data may indicate desire for a custom presentation and provide information about same, which may then be communicated to the presenter 102 (without communicating the identity of the sponsor 106) who can prepare and deliver a presentation for the sponsor 106 that fits the content that was specified.

At 306, the first data describing an aspect of the biomedical presentation may be associated with the identity of the sponsoring entity 106. For example, a record of the sponsorship may be stored in a database.

At 308, an indication may be generated that the presenter 102 is to deliver the presentation. The indication preferably does not disclose the identity of the commercial interest sponsor 106. For example, the indication may be an invitation to deliver the biomedical presentation. Where the funding was solicited for a biomedical presentation already coordinated for delivery, the indication may be a confirmation that the delivery has gained a sponsor.

The indication may be sent to a host 108 of the biomedical presentation. The indication may be sent to a sponsor 106 of the biomedical presentation. For example, the indication may be used to shop for a sponsor for a biomedical presentation already setup between the presenter, host, and/or facilitator.

The indication may be associated with logistic information, such as location, venue, directions, date, time, schedule changes, and the like. The logistic information may be indicative of a host 108 and/or facilitator 104. The logistic information may be sent without the sponsor's identity being revealed. The logistical information may be sent to a potential audience member without identifying the identity of the sponsoring entity 106. For example, the interface 202 may send an e-mail invitation to a list of attendees that does not disclose the identity of the sponsor 106.

With regard to the communications and/or interactions associated with receiving the first data (i.e., at 302), with receiving the second data (i.e., at 304), and/or with generating an indication (i.e., at 308), the methods may include actions that maintain blinding between the sponsor 106 and the presenter 102. These actions may include layering various agreements, such as digital “click-through” contracts, that require the parties to ensure that the identity of the sponsor 106 is not discovered by the presenter 102 and, if this is breached, to report knowledge of this breach to the interface 102. Preferably, the methods comprise receiving from the sponsor 106 its agreement that it will not communicate its identity to the presenter 102. The blinding methods may further comprise communicating to the presenter 102 an expectation that the presenter 102 will avoid learning the identity of the sponsor 106. Preferably, the methods comprise receiving from the presenter 102 its agreement that it will avoid learning the identity of the sponsor 106. Alternatively, the methods may comprise receiving a request from the presenter 102 for the identity of the sponsor 106 and refusing to disclose the identity of the sponsor 106 in response to the request. The methods may include requiring the biomedical presenter 102, sponsor 106, and/or facilitator 104, and/or host to agree to prevent, prohibit, or protect the biomedical presenter 102 from learning the identity of the sponsoring commercial interest entity 106.

The blinding agreements may be tied to consideration associated with the delivery of the biomedical presentation. For example, the blinding methods may include receiving consideration (which may include an honorarium for the presenter 102) associated with the delivery of a biomedical presentation from a sponsor 106 that has an identity and agreeing to avoid learning the identity of the sponsor 106. For example, a biomedical presenter 102 may receive consideration for delivering a presentation, directly or indirectly, from a commercial sponsor 106 and may agree to avoid learning the identity of the sponsor 106. The blinding methods may include providing consideration associated with the delivery of the biomedical presentation to the presenter 102 and agreeing not to communicate identity of the sponsor 106 to the presenter 102. For example, a commercial interest sponsor 106 may provide money directly (and/or indirectly via a facilitator 104 and/or host 108) to a biomedical presenter 102 and agree not to communicate its identity to the presenter 102.

These blinding agreements may extend beyond the parties directly involved in the exchange. For example, the methods may further comprise communicating to an audience member an expectation that the audience will not communicate the identity of the sponsor 106 to the individual. Preferably, the methods comprise receiving from an audience member its agreement that it will not communicate the identity of the sponsor 106 (if known) to the presenter 102. These agreements may be coordinated in electronic invitations to the sponsored biomedical presentation.

A message may be sent to confirm that the indication was generated. For example, a message may be sent to a sponsor 106 that the indication to deliver the biomedical presentation has been generated and/or sent to the presenter 102. The message may serve as a confirmation that the system processed the request that the biomedical presentation be delivered.

At 310, the biomedical presentation may be delivered by the presenter 102. The presentation may be delivered by any of the following methods: live in-person, webcast, podcast, real-time feed, download, or the like. The identity of the sponsor 106 may continue to be blinded, even after delivery of the biomedical presentation.

In certain embodiments, the identity of the sponsor 106 is disclosed after delivery of the biomedical presentation. For example, after delivery of the biomedical presentation, the identity of the sponsor 106 may be disclosed to the presenter 102, the facilitator 104, and/or the audience members. The interface 202 may generate an e-mail message disclosing the identity of the sponsor 106.

The methods disclosed may include the provision of a feedback loop to ascertain and help ensure effective blinding of the presenter 102 to the identity of the sponsoring commercial interest entity 106. For example, at 312, information indicating whether identity of the sponsor 106 was known by the presenter 102 before delivering the biomedical presentation may be collected. This information may be collected in response to a query. To help ensure the efficacy of the blinding methods, the methods may further comprise collecting feedback from the presenter 102 after the delivery of the presentation about whether the presenter 102 discovered the identity of the sponsoring commercial interest entity 106. For example, the interface 202 may send a post-program audit to the presenter 102 in order to ascertain whether effective blinding has been achieved (whether the presenter 102 learned the identity of the commercial interest sponsor 106). The information indicating whether identity of the sponsor 106 was known before delivering the biomedical presentation may be collected from the presenter 102.

At 314, a compliance metric may be generated based on the collected information. The compliance metric may be indicative of the effectiveness of the blinding methods and systems in practice. The compliance metric may be associated with a presenter 102, facilitator 104, and/or a commercial interest sponsor 106. The compliance metric may be indicative of the level of cooperation from a specific presenter 102, facilitator 104, and/or commercial interest sponsor 106. For example, if feedback generates a compliance metric associated with a particular commercial interest sponsor 106 that is indicative of presenters 102 consistently learning the sponsor's 106 identity, a corrective action may be taken. For example, the agreements associated with the sponsor 106 may be changed. For example, the sponsor 106 may be denied from further participation with the interface 202. The compliance metric may be provided to sponsors to assist sponsors with reporting the integrity of their sponsoring practices to regulatory bodies.

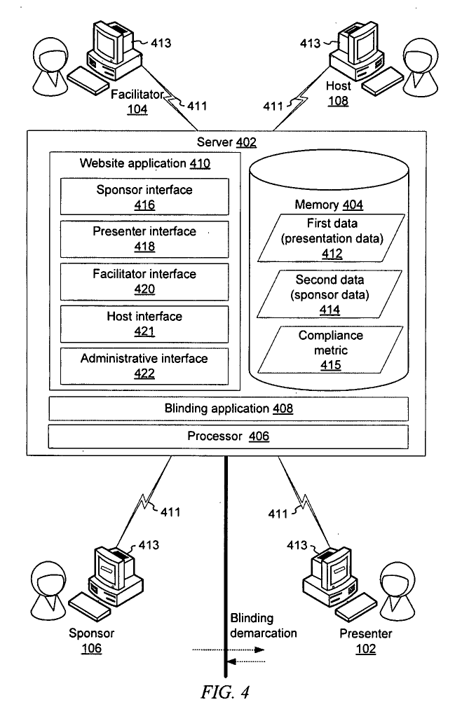

FIG. 4 depicts an exemplary system for facilitating sponsored biomedical presentations. The system may enable interaction with the commercial interest sponsor 106, presenter 102, facilitator 104, and/or host 108 through a website or other graphical user interface, email, telephone or any other mode or medium of communication. The system may coordinate, schedule, arrange, broker, or otherwise set up a biomedical presentation in which the presenter 102 is blinded to the identity of the sponsor 106. The system may enable solicitation and/or selection a sponsor 106 and/or a presenter 102. The system may enable the shopping of presentations to various parties, for example, shopping of sponsored presentations to hosts 108 (e.g. hospitals, medical centers or academic institutions) without identifying the identity of the commercial interest entity 106 to either the presenter 102 or the hospital, medical center or academic institution, or shopping presentations to sponsor to commercial interest entities 106.

The system may include a server 402, such as web server, that includes a memory 404, a processor 406 in communication with the memory 404, a blinding application 408, and a website application 410.

The server 402 may communicate via a network 411 to client computers 413. The network 411 may include any system, subsystem, and/or component suitable for transmitting voice and/or data. The network 411 may be the Internet. The network 411 may a telephone network, a wireless voice network, a wireless data network, a wired voice network, a wired data network, and the like. The network 411 may be virtual private network (VPN).

Each client computer 413 may communicate with the server 402 via a client application running on the client computer 413. The client application may include a thin client, a web browser, a database client, a terminal client, and/or an executable application. The client application may enable the presenter 102, sponsor 106, facilitator 104, and/or the host 108 to interact with the server 402.

The processor 406 may include any system, subsystem, and/or component suitable for processing digital data. For example, the processor 406 may be a computer microprocessor. The processor 406 may include a distributed computer processing system. The memory 404 may include any system, subsystem, and/or component suitable for storing data. The memory 404 may include volatile memory and/or non-volatile memory. The memory 404 may include random access memory, flash memory, magnetic disk memory, and the like. The memory 404 have stored therein data structured in accordance with a database. The database may define a schema, including a set of primary and secondary keys, that link and/or logically associate data stored in the memory 404 with one another.

The processor 406 and the memory 404 may cooperate to run the blinding application 408 and the website application 410. The blinding application 408 may include computer executable instruction that when executed in connection with the processor 406 and the memory 404 enable a blinding system, such as that disclosed in FIG. 3. For example, the memory 404 may have stored therein first data 412 that describes an aspect of a biomedical presentation that is associated with a presenter 102 (or alternatively a custom presentation request generated by a sponsor 106, facilitator 104, or host 108). The processor 406 may receive second data 414 indicative of an intent of a commercial interest sponsor 106 to sponsor delivery of the biomedical presentation. The processor 406 may associate the first data 412 with an identity of the sponsoring entity 106. For example, the processor 406 may establish a linkage between the portion of memory 404 storing the first information and a portion of memory 404 storing the identity of the sponsoring entity 106. The processor 406 may engage a database engine to maintain this linkage. A record of the linkage may be physically stored in the memory 404. The processor 406 may generate an indication to the presenter 102 to deliver the biomedical presentation. The indication preferably does not disclose the identity of the sponsoring entity 106 to the presenter 102.

The processor 406 may collect information indicating whether the presenter 102 knew the identity of the sponsor 106 before delivering the biomedical presentation. For example, the processor 406 may receive one or more indicators (e.g. email transmission or response to a query) containing feedback from the presenter 102. The presenter 102 may provide information to the processor 406 via a website interface. The processor 406 may store the collected information in memory 404. The processor 406 may generate a compliance metric 415 based on the collected information. The processor 406 may store the compliance metric 415 in memory 404. The processor 406 may make the compliance metric 415 available via one or more website interfaces.

The processor 406 may collect information indicating whether the presenter 102 knew the identity of the sponsor 106 before delivering the biomedical presentation. For example, the processor 406 may receive one or more e-mails containing feedback from the presenter 102. The presenter 102 may provide information to the processor 406 via a website interface. The processor 406 may store the collected information in memory 404. The processor 406 may generate a compliance metric 415 based on the collected information. The processor 406 may store the compliance metric 415 in memory 404. The processor 406 may make the compliance metric 415 available via one or more website interfaces.

The server 402 may be located anywhere in the world and act to facilitate the engagement of a U.S. presenter 102 to prepare or provide a biomedical presentation using funding from a commercial interest sponsor 106 without informing the presenter 102 of the identity of the commercial interest 106. A U.S.-based server 402 may facilitate the engagement of a foreign biomedical presenter 102 to prepare or provide a presentation using funding from a commercial interest sponsor 106 while taking steps to blind the foreign presenter 102 to the identity of the commercial interest 106. In another embodiment, the server 402 may be located anywhere in the world and act to facilitate the engagement of a non-U.S. presenter 102 to prepare or provide a presentation using funding from a U.S. or multinational commercial interest 106 while taking steps to blind the non-U.S. presenter 102 to the identity of the commercial interest 106. In yet another embodiment, the system, any part of which may be located in the United States, may be used to facilitate the engagement of a biomedical presenter 102 to prepare or provide a presentation using funding from a commercial interest 106 while blinding the presenter 102 to the identity of the commercial interest 106. For example, the blinding process may be effected by using a system, a network 411, and/or a programmed server 402 located anywhere in the world. Such systems, networks 411, and/or programmed servers 402 could be assembled by one of skill in the art in the appropriate computer fields. The beneficial use of such systems, networks 411, and/or servers 402 is understood to occur in the U.S. if any part of the system is located in the U.S., and/or when a presenter 102 or sponsoring commercial interest entity 106 is located in the U.S. during any time that such systems, networks 411, and/or servers 402 are used to effect blinding of a presenter 102.

The website application 410 may provide an graphical interface 202 for the blinding application 408. The website application 410 may define one or more interfaces such as a sponsor interface 416, a presenter interface 418, a facilitator interface 420 a host interface 421, and/or an administrative interface 422.

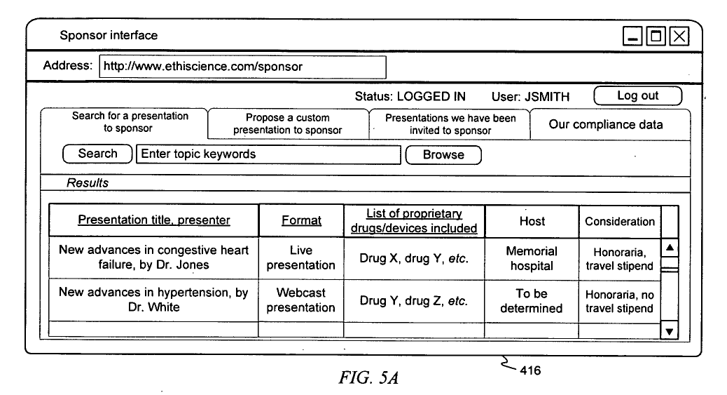

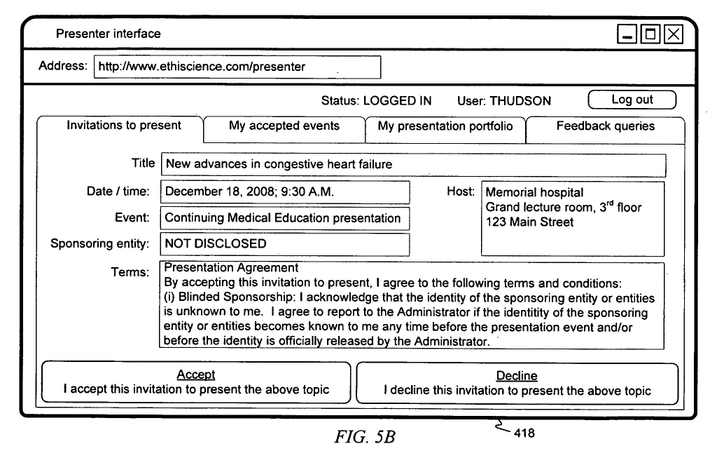

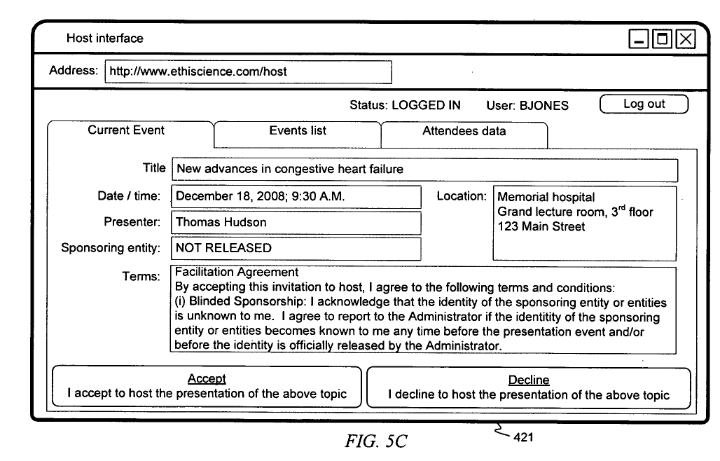

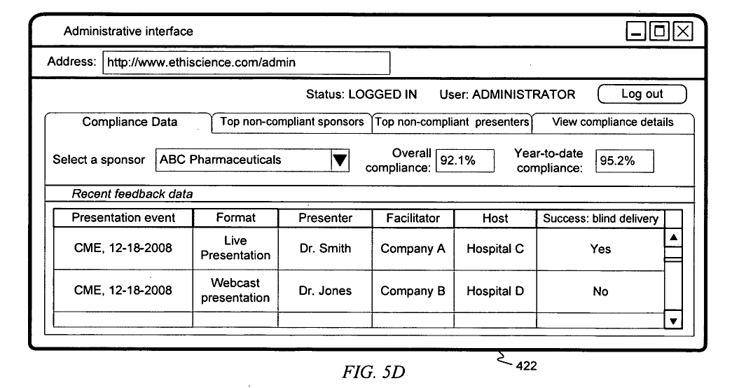

FIGS. 5A-D depict exemplary user interfaces for facilitating a sponsored biomedical presentation, including the sponsor interface 416, the presenter interface 418, the host interface 421, and the administrative interface 422, respectively.

As depicted in FIG. 5A, the sponsor interface 416 may enable a commercial interest sponsor 106 to interact with the server 402. For example, the sponsor interface 416 may enable the commercial interest sponsor 106 to search for topics and presentation, to submit custom content for a presentation they want to sponsor, view presentations they are being invited to sponsor, make an offer to sponsor or agree to sponsor, view past presentations that the sponsor 106 has funded, track compliance (including compliance of their sponsored presentations with the blinding methods), and view or download a compliance metric 415.

In response to a query, the sponsor interface 416 may present a listing of presentations consistent with the query. The sponsor 106 may select a presentation from this list to fund. In this regard, the interface 202 enables presentation shopping. For example, an interface 202 may collect, build and/or display a portfolio of presentations from a biomedical presenter 102 and transmit, offer, and/or provide the portfolio of presentations to a commercial interest sponsor 106 so that the entity can select a presentation and presenter for its purposes.

The portfolio of presentations may include titles, outlines of content, a list of all proprietary drugs and/or devices to be discussed, and a complete list of references utilized for each presentation. The biomedical presenter may set its own honoraria for these presentations that can be commissioned through the interface 202 so that the presenter is appropriately compensated for his or her time. In this web-based embodiment, the commercial interest sponsor 106 may establish an account and log on to view the various portfolios from numerous biomedical presenters 102. The portfolio information may be provided to the sponsoring entity 106 using email, facsimile, written, phone or any other possible medium of exchanging information. The commercial interest may review the content of the various outlines and select a presentation to sponsor. In one embodiment, the sponsor 106 may send electronic invitations to to potential attendees of a biomedical presentation via the sponsor interface 416.

The sponsor 106 may agree to certain terms set forth by the sponsor interface 416 and may agree to pay honoraria and/or a travel stipend. For example, a commercial interest 106 (and/or any individual or entity using funding from a commercial interest 106 that desires to sponsor a presentation, such as a facilitator 104 and/or a host 108), may be asked to agree to one or more of the following provisions:

(a) to not circumvent the interface 202 by directly communicating with the presenter 102 about utilization of the interface's 202 service;

(b) to not collaborate with the presenter 102 in such a way that communicates instructions about securing his or her services through the interface 202;

(c) to not communicate with the presenter 102 about dates, names of venues, or names of conferences, or any other information that would make the identity of the sponsor 106 known when the presenter 102 participates in the program;

(d) that, prior to each sponsored biomedical presentation, the presenter 102 will acknowledge (verbal and/or in print/slide form) that he or she has been blinded to the identity of the sponsor 106 and/or has agreed to remain blinded to the identity of the sponsor 106 and ask that the identity of the sponsor 106 (if known by an audience member) not be communicated to he or she either before, during, or after the biomedical presentation and/or that he or she agrees to notify the interface 202 if he or she has knowledge that this does not occur;

(e) the commercial interest sponsor 106 understands that the presenter is under agreement to notify the interface 202 if engaged in any manner that compromises the blinding process;

(f) that the commissioned biomedical presentation will be presented as outlined in the interface 202 and will not significantly deviate from the content as it appeared in the interface 202 at the time that the invitation to present was accepted;

(g) that each presentation will be balanced according to a specific formula or weighting methodology, for example for allocating the time/slide count/word count/etc, again for example, 30% disease state information [including epidemiology, definitions, physiology, pathophysiology (i.e. not treatment related)], and no more than 25% focused on any single drug, device, or other proprietary technology;

(h) that the commercial interest sponsor 106 will be assigned a unique identifier code number and the number will be the only identifier used in all reporting (either internal reporting or in regulatory affairs);

(i) that when the commercial interest sponsor 106 is reviewing presentations in order to select a presentation to sponsor, it will not have any access to details of a presenter's participation in other interface 202 programs (i.e. volume of sponsored talks, identity of other industry clients using a particular presenter, etc.);

j) if the commercial interest 106 learns that the a presenter 102 has learned the identity of the sponsoring commercial interest 106, it agrees to notify the interface 202 immediately following the program;

(k) that the commercial interest 106 will pay the interface 202 the specified amount of money of the honoraria listed in the presenter's portfolio, and this will be paid as an unrestricted educational grant or in-kind support;

(l) that the commercial interest 106 will pay the interface 202 the specified amount of money of the transaction fee associated with a presentation;

(m) that the commercial interest 106 (or facilitator 104) will send all invitations to program participants (i.e. audience) via electronic invitations from the interface 202 if applicable;

(n) that the electronic invitations will notify the invitee of the interface's policies;

(o) that the electronic invitations will notify the invitee of the fact that the presenter 102 must remain blinded to the identity of the sponsor 106 (if known by the invitee);

(p) that the electronic invitations may not identify the identity of the sponsor 106; and

(q) if there are verbal invitations to individual potential audience members, there may also be electronic invitations sent to notify the invitee of the fact that the presenter may remain blinded to the identity of the sponsor 106 (if known by the invitee).

The facilitator interface 420 may present a similar screen layout, similar data fields, and similar functionality as the sponsor interface 416. Because the facilitator 104 may act on behalf of a sponsor 106, the facilitator interface 420 may offer similar functionality. Additionally, the facilitator interface 420 may include a data field for the facilitator 104 to enter the identity of the sponsor 106 and/or other parties on whose behalf the facilitator is acting.

As depicted in FIG. 5B, the presenter interface 418 may provide the graphical and textual tools to enable interaction between the interface 202 and the presenter 102. Information may be transmitted, for example, by uploading presentation outlines on a website, or another graphical user interface, or through email, by telephone or through any other mode or medium of communication by which information may be transmitted. For example, the presenter interface 418 may enable the presenter 102 to log-in and view/edit/upload biomedical presentations and/or outlines. The presenter interface 418 may enable the presenter 102 to view accepted events for delivery of presentations. The presenter interface 418 may provide to the presenter 102 the indication that a presentation has been sponsored. For example, the presenter interface 418 may display the topic, the date/time/location for the delivery of the presentation, and a click-through contract regarding the terms of agreement for blinded sponsorship.

The presenter interface 418 may enable the presenter 102 to accept or decline delivery of the presentation and execute the click-through contract. For example, the presenter may be required to agree to one or more of the following provisions:

(a) to not circumvent the interface 202 by communicating with commercial interests 106, including representatives of commercial interest sponsors 106 and/or any individual or entity using funding from a commercial interest sponsor 106, such as a facilitator 104, about utilization of the interface's services;

(b) to not communicate instructions to commercial interest sponsor 106 and/or any individual or entity using funding from a commercial interest sponsor 106, such as a facilitator 104, about securing the presenter's services through the interface 202;

(c) to not communicate with commercial interest sponsor 106, including representatives of commercial interest sponsor 106 and/or any individual or entity using funding from a commercial interest sponsor, such as a facilitator 104, about dates, names of venues, or names of conferences, or any other information that would make the identity of the sponsor 106 known when the presenter 102 participates in the program;

(d) to only communicate to commercial interest sponsor 106, including representatives of commercial interest sponsor 106 and/or any individual or entity using funding from a commercial interest sponsor 106, such as a facilitator 104, that the presenter participates in the interface 202 and that the representative needs to contact the interface 202 to pursue the presenter's 102 services further;

(e) if he or she accepts personal remuneration (honoraria, speaking fees, consulting fees, etc.) directly from commercial interest sponsor 106 (either directly from a commercial interest representative or indirectly through a third party working on behalf of the commercial interest sponsor, e.g. a facilitator 104) outside of the interface 202, or if the presenter has other financial interests (including stock, patent rights, royalties, etc.) from a commercial interest sponsor 106, the presenter 102 will disclose any and all of these financial relationships (including the name of the commercial interest sponsor 106 as well as the name of any specific product) in (1) his or her presentations (both interface-mediated and non-interface-mediated presentations) in accordance with existing codes of ethics and (2) all publications submitted to peer-review journals (in accordance with the journal's instructions to authors);

(f) to disclose that he or she has received honoraria from the interface 202 and he or she is a member or client of (or has a relationship with) the interface 202 in all presentations, lectures/speaking engagements (including those that are not mediated by the interface 202), and all manuscripts submitted to peer-reviewed journals;

(g) prior to each program, to acknowledge (verbal and/or in print/slide form) that he or she is blinded to the identity of the commercial sponsor 106 and has agreed to remain blinded to the identity of the sponsor 106 and ask that the identity of the sponsor 106 (if known) not be communicated to he or she by any member of the audience either before, during, or after the biomedical presentation;

(h) to answer queries as part of a quality control and feedback loop as well as internal audits from the interface 202;

(i) that each presentation outline in his or her portfolio will list all proprietary technologies, devices, or drugs that will be discussed or displayed in slide/print format, and that his or her presentation will not discuss or display any proprietary technologies, devices, or drugs that was not listed in the outline in his or her portfolio at the time he or she accepted the agreement;

(j) to present the commissioned biomedical presentation as it appears in the outline in his or her portfolio (or the outline of a presentation topic/content as received from the interface 102), and not to significantly deviate from the content as it appeared in the portfolio at the time that he or she accepted the agreement;

(k) to give the presentation (the same presentation listed in his or her invitation to participate) that was selected for a specific forum;

(l) that each of his or her presentations will be balanced according to a specific formula or weighting methodology, for example for allocating the time/slide count/word count/etc, again for example, 30% disease state information [including epidemiology, definitions, physiology, pathophysiology (i.e. not treatment related)], and no more than 25% focused on any single drug, device, or other proprietary technology;

(m) that he or she will be assigned a unique identifier code number (upon becoming a client of the interface 202) and this number will be the only identifier used for he or she in all reporting (either internal reporting or in regulatory affairs);

(n) that when commercial interest sponsors 106, including representatives of commercial interest sponsor 106 and/or any individual or entity using funding from a commercial interest sponsor 106 such as facilitators 104, are reviewing portfolios for the purposes of selecting a program, they will be able to see all of the presentations in his or her portfolio and may know his or her identity; however, will not have any access to details of his or her participation in interface 202 programs (i.e., volume of sponsored presentations, the identity of other commercial interests 106 sponsoring the programs he or she participates in, etc.).

(o) he or she will be blinded to the proportion of his or her programs that were sponsored by any single commercial interest sponsor 106, and will not know or have access to how many different commercial interests 106 have sponsored his or her programs; and

(p) that if he or she learns the identity of the sponsoring commercial interest 106, he or she agrees to notify the interface 202, including through a feedback mechanism, immediately following the program.

As depicted in FIG. 5C, the host interface 421 may enable a third party host 108 to coordinate logistic information regard delivery of the presentation. For example, the host interface 421 may enable the setting and editing of the date, time, location, etc. associated with the delivery of the presentation. The host interface 421 may include a listing of attendee and corresponding attendee data, such as name and e-mail address. The host interface 421 may enable the host 108 to accept or decline hosting a particular event. The host interface 421 may require that the host 108 agree to terms and conditions via a click-through contract.

The host interface 421 may enable the host 108 to send electronic invitations to attendees. To assemble an audience and maintain a blinded process, the methods may comprise sending an invitation to the biomedical presentation to a potential audience member. The invitations may be sent to potential audience members, for example, via the interface 202 using an electronic invitation (e.g., email) on behalf of the sponsor (with or without identification of the sponsor 106). The electronic invitation may specify the blinded nature of the sponsorship (i.e., that the presenter is blinded to the identity of the sponsor 106) and other terms of the interface 202. Audiences for these programs, set up through the blinding process, preferably are not limited to physicians, but may be anyone, including healthcare administrators, non-clinician scientists, nurses, therapists, technicians, or any allied health professional.

As depicted in FIG. 5D, the administrative interface 422 may enable an administrator to process transactions in the interface 202, and collect and track compliance data. As indicated above, to help ensure the efficacy of the blinding methods, the methods may further comprise collecting feedback from the presenter 102 (and may also include feedback from the sponsor 106, facilitator 104, host 108 and/or attendees) after the delivery of the presentation about whether the presenter 102 discovered the identity of the sponsoring commercial interest 106. For example, the interface 202 may send a post-presentation audit to the presenter 102 in order to ascertain whether effective blinding has been achieved (whether the presenter 102 learned the identity of the commercial interest entity 106). The interface 202 may send a post-presentation audit to the presenter 102 (or the sponsor 106, attendees, host 108, and/or facilitator 104).

Based on the received feedback, the processor 406 may generate one or more compliance metrics. The metrics may be displayed via the administrative interface 422. For example, the compliance metrics may be associated with presenters 102, facilitators 104, and sponsors 106, such that the interface 202 may track and provide metrics on the record of compliance of all participants, enabling an administrator to take corrective action as needed.

What is claimed:

1. A computer system comprising:
a memory having stored therein first data that describes an aspect of a biomedical presentation, and
a processor that is in communication with the memory and that receives second data indicative of an intent of an entity that the biomedical presentation be delivered, and that generates an indication to deliver the biomedical presentation, wherein the indication does not disclose the identity of a sponsor of the biomedical presentation to a presenter of the biomedical presentation.

2. The computer system of claim 1, wherein the first data is associated with the presenter.

3. The computer system of claim 1, wherein the second data is associated with the sponsor.

4. The computer system of claim 1, wherein the processor sends the first data responsive to a query.

5. The computer system of claim 4, wherein the first data is sent as part of a list of presentations consistent with the query, and wherein the second data comprises a selection from the list of presentations.

6. The computer system of claim 4, wherein the first data is sent as part of a list of presentations consistent with the query, wherein the second data indicates at least a plurality of presentations are acceptable, and wherein the processor selects the presentation from the plurality of presentations of the list that are acceptable.

7. The computer system of claim 1, wherein the first data is received by the processor as a request for a custom presentation, and wherein the indication includes the first data.

8. The computer system of claim 1, wherein the indication includes instructions that the presenter is to deliver the biomedical presentation consistent with the first data.

9. The computer system of claim 1, wherein the indication is sent to the presenter.

10. The computer system of claim 1, wherein the entity is the sponsor of the biomedical presentation.

11. The computer system of claim 1, wherein the processor sends the first data and receives the second data in response.

12. The computer system of claim 1, wherein the entity is a facilitator of the biomedical presentation.

13. The computer system of claim 1, wherein the second data is associated with an agreement that contains a requirement not to disclose the identity of the sponsor to the presenter.

14. The computer system of claim 13, wherein the agreement is a digital contract.

15. The computer system of claim 1, wherein the indication is associated with an agreement that requires the presenter to avoid learning the identity of the sponsor.

16. The computer system of claim 15, wherein the agreement is a digital contract.

17. The computer system of claim 1, wherein the indication is associated with an agreement that requires the presenter to provide truthful statement in response to an audit.

18. The computer system of claim 17, wherein the agreement is a digital contract.

19. The computer system of claim 1, wherein the processor sends a message that discloses the identity of the sponsor after delivery of the presentation.

20. The computer system of claim 19, wherein the message is sent to the presenter.

21. The computer system of claim 19, wherein the message comprises an e-mail sent to an attendee of the presentation.

22. The computer system of claim 1, wherein the processor receives the second data via a website interface.

23. The computer system of claim 1, wherein the processor collects third data from the presenter regarding whether the presenter knew the identity of the sponsor.

24. The computer system of claim 23, wherein the processor collects the third data after delivery of the presentation.

25. The computer system of claim 1, wherein the processor generates a compliance metric based on whether the presenter knew the identity of the sponsor.

26. The computer system of claim 1, wherein the memory has stored therein an electronic file created by the presenter that contains the biomedical presentation.

27. The computer system of claim 1, wherein the sponsor of the biomedical presentation is a pharmaceutical company.

28. The computer system of claim 1, wherein the sponsor of the biomedical presentation is a medical device company.

29. The computer system of claim 1, wherein the indication is sent via an e-mail message.

30. The computer system of claim 1, wherein the sponsor of the biomedical presentation is a source of payment to the presenter for delivery of the biomedical presentation.

31. The computer system of claim 1, wherein the biomedical presentation is a Continuing Medical Education program.

32. A method comprising:
receiving first data describing an aspect of a biomedical presentation;
receiving second data indicative of an intent of an entity that the biomedical presentation be delivered; and
generating an indication to deliver the biomedical presentation, wherein the indication does not disclose the identity of a sponsor of the biomedical presentation to a presenter of the biomedical presentation.

33. The method of claim 32, wherein the first data is associated with the presenter.

34. The method of claim 32, wherein the second data is associated with the sponsor.

35. The method of claim 32, further comprising sending the first data responsive to a query.

36. The method of claim 35, wherein sending the first data comprises sending a list of presentations consistent with the query, wherein the second data comprises a selection from the list of presentations.

37. The method of claim 35, wherein sending the first data comprises sending a list of presentations consistent with the query, wherein the second data indicates that at least a plurality of the presentations of the list are acceptable, and further comprising selecting the presentation from the plurality of presentations of the list that are acceptable.

38. The method claim 32, wherein the first data includes a request for a custom presentation and the indication includes the first data.

39. The method of claim 32, wherein the indication includes instructions that the presenter is to deliver the biomedical presentation consistent with the first data.

40. The method of claim 32, wherein the indication is sent to the presenter.

41. The method of claim 32, wherein the entity is the sponsor of the biomedical presentation.

42. The method of claim 32, further comprising sending the first data, wherein receiving the second data comprises receiving the second data in response to sending the first data.

43. The method of claim 32, wherein the entity is a facilitator of the biomedical presentation.

44. The method of claim 32, wherein the second data is associated with an agreement that contains a requirement not to disclose the identity of the sponsor to the presenter.

45. The method of claim 44, wherein the agreement is a digital contract.

46. The method of claim 32, wherein the indication is associated with an agreement that requires the presenter to avoid learning the identity of the sponsor.

47. The method of claim 46, wherein the agreement is a digital contract.

48. The method of claim 32, wherein the indication is associated with an agreement that requires the presenter to provide truthful statement in response to an audit.

49. The method of claim 48, wherein the agreement is a digital contract.

50. The method of claim 32, further comprising disclosing the identity of the sponsor after delivery of the presentation.

51. The method of claim 50, wherein disclosing the identity of the sponsor comprises disclosing the identity of the sponsor to the presenter.

52. The method of claim 50, wherein disclosing the identity of the sponsor comprises sending an e-mail to an attendee of the presentation.

53. The method of claim 32, further comprising receiving consideration associated with delivery of the presentation from the sponsor and distributing the consideration to the presenter.

54. The method of claim 32, further comprising receiving a request from the presenter for the identity of the sponsor, and refusing to disclose the identity in response to the request.

55. The method of claim 32, wherein the second data is received using a website interface.

56. The method of claim 32, further comprising taking an action to prevent the presenter from learning the identity of the sponsor.

57. The method of claim 32, further comprising collecting third data from the presenter regarding whether the presenter knew the identity of the sponsor.

58. The method of claim 57, wherein the collecting third data occurs after delivery of the presentation.

59. The method of claim 32, further comprising generating a compliance metric based on whether the presenter knew the identity of the sponsor.

60. The method of claim 32, wherein the presentation is to be presented by any of live in-person, webcast, podcast, real-time feed, or download.

61. The method of claim 32, wherein the sponsor of the biomedical presentation is a pharmaceutical company.

62. The method of claim 32, wherein the sponsor of the biomedical presentation is a medical device company.

63. The method of claim 32, wherein the indication is sent via an e-mail message.

64. The method of claim 32, wherein the sponsor of the biomedical presentation is a source of payment to the presenter for delivery of the biomedical presentation.

65. The method of claim 32, wherein the biomedical presentation is a Continuing Medical Education program.

66. A method comprising:
receiving first data describing an aspect of a biomedical presentation;
generating second data indicative of an intent of an entity that the biomedical presentation be delivered; and
receiving a message indicative of an indication to deliver the biomedical presentation having been generated, wherein the indication does not disclose the identity of a sponsor of the biomedical presentation to a presenter of the biomedical presentation.

67. The method of claim 66, further comprising providing consideration to the presenter for delivery of the biomedical presentation such that the payment does not disclose the identity of the sponsor of the biomedical presentation to the presenter of the biomedical presentation.

68. The method of claim 66, further comprising receiving a compliance metric based on whether the presenter knew the identity of the sponsor.

69. The method of claim 66, wherein the second data is associated with an agreement that contains a requirement not to disclose the identity of the sponsor to the presenter.

70. The method of claim 69, wherein the agreement is a digital contract.

71. The method of claim 66, wherein the indication is associated with an agreement that requires the presenter to avoid learning the identity of the sponsor.

72. The method of claim 66, wherein the indication is associated with an agreement that requires the presenter to provide truthful statement in response to an audit.

73. The method of claim 66, wherein the sponsor of the biomedical presentation is a pharmaceutical company.

74. The method of claim 66, wherein the sponsor of the biomedical presentation is a medical device company.

75. A method comprising:
sending first data describing an aspect of a biomedical presentation;
generating second data indicative of an intent of an entity that the biomedical presentation be delivered; and
receiving a message indicative of an indication to deliver the biomedical presentation having been generated, wherein the indication does not disclose the identity of a sponsor of the biomedical presentation to a presenter of the biomedical presentation.

76. A method of tracking a biomedical presentation that is associated with a presenter and a sponsor, comprising:
collecting information indicating whether the presenter knew the identity of the sponsoring entity before delivering the biomedical presentation; and
generating a compliance metric based on the collected information.

77. The method of claim 76, wherein the collecting information comprises collecting information from the presenter.

78. The method of claim 76, wherein the collecting information comprises collecting information from an attendee of the biomedical presentation.

79. The method of claim 76, wherein the compliance metric is associated with the presenter.

80. The method of claim 76, wherein the compliance metric is associated with the sponsor.
